(19) United States
(12) Patent Application Publication
(10) Pub. No.: US 2017/0083168 A1
(43) Pub. Date: Mar. 23, 2017

(54) SYSTEM AND METHOD FOR MANAGING MULTIPLE CHAT SESSIONS

(71) Applicant: IDT Messaging, LLC, Newark, NJ (US)

(72) Inventor: Jonathon Chad Linner, Fort Lauderdale, FL (US)

(21) Appl. No.: 15/141,258

(22) Filed: Apr. 28, 2016

Related U.S. Application Data
(60) Provisional application No. 62/150,032, filed on Apr. 20, 2015.

(51) Int. Cl. G06F 3/0481; H04W 4/12; H04L 12/58

(52) U.S. Cl. CPC G06F 3/0481; H04L 51/22; H04W 4/12; H04L 51/04

(57) ABSTRACT

A multichat messaging feature enables a user of the device to keep track of and manage multiple chats at once. A quickswitch area includes empty slots that can be filled by the user with avatars corresponding to one to one or group chats. Each avatar is displayed with an indicator showing whether there are new messages within the corresponding chat. The avatars in the quickswitch area may be ordered according to the recency of the messages in the associated conversations. The user has the ability to open a conversation that corresponds to an avatar in the quickswitch area by dragging that avatar from the quickswitch area to either an active conversation area or inactive conversation area. The active conversation area corresponds to a conversation in which the user is actively engaged and has a different visual appearance than the inactive conversation area. The active conversation area, in addition to the text of the active conversation, may include a contact name and avatar for the individual or group participating in the conversation with the user of the device. The inactive conversation area, in addition to selected text of the inactive, but open, conversation, includes an avatar and/or a contact name for the individual or group involved in the inactive conversation.

### FIELD OF INVENTION

The present invention is directed to a system and method for managing multiple chat sessions on a graphical user interface.

### DISCUSSION OF THE BACKGROUND

A user can typically engage in one to one or group chat sessions with other users on a mobile device or computer. But the user may need or want to engage in or be adequately informed about multiple chat sessions at approximately the same time. Traditionally, a graphical user interface enables a user to view and manage only one chat session at a time.

### BRIEF DESCRIPTION OF THE DRAWINGS

The following description, given with respect to the attached drawings, may be better understood with reference to the non-limiting examples of the drawings, wherein:

FIG. 1 is a diagram of a graphical user interface of a device with a multichat messaging feature and showing an active conversation area being interacted with;

FIG. 2 is a diagram of a graphical user interface of a device with a multichat messaging feature where the active and inactive areas are switched;

FIGS. 3A-3C depict an exemplary series of operations of a multichat messaging feature that is being used on a device for the first time;

FIGS. 4A and 4B are diagrams of a graphical user interface of a device with a multichat messaging feature showing how the multichat mode is closed; and

FIGS. 5A and 5B are diagrams of a graphical user interface of a device depicting the activation of a multichat messaging feature by dragging a contact identifier.

### DISCUSSION OF THE PREFERRED EMBODIMENTS

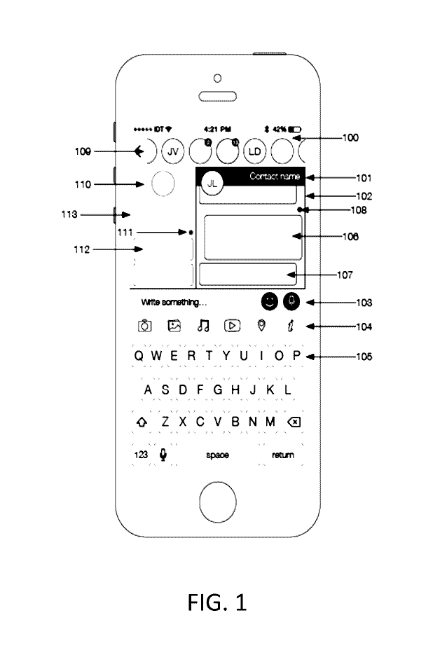

FIG. 1 is a diagram of a graphical user interface of a device with a multichat messaging feature. The device of FIG. 1 is shown to be a mobile phone, but one of ordinary skill in the art will appreciate that other devices can implement a multichat messaging feature, such as a tablet device, desktop computer, laptop computer, or any other device on which messaging with a remote user is possible.

The multichat messaging feature enables a user of the device to keep track of and manage multiple messaging conversations (e.g., chats) at once. The messaging conversations can be SMS chats, instant messaging chats, or any other type of chat that enables a user of the device to communicate with one or more other people. The multichat messaging feature, for example, uses a graphical user interface that may include a number of controls and areas, including those depicted in FIGS. 1-5B. The interface of FIG. 1 includes a number of exemplary interface areas or regions including: quickswitch area 100, active conversation area 102 (which includes a contact name area 101, right adjusted messages from the user (i.e., the user's own messages) 106, left adjusted messages from other users 107, and a collapsed message indicator 108), text/voice input area 103 (which includes a message box, smiley face button and voicenote button), attachment tray 1-4, system keyboard 105, back button 109 (with hide functionality for avatars), an inactive conversation area 113 for inactive conversations including inactive avatar 110, own message indicator 111, other people's message(s) (for the inactive conversation(s)).

FIG. 1 depicts the operation of a quickswitch area 100. Quickswitch area 100 is an area where a user of the device can place avatars corresponding to one to one or group chats in which the user is participating. Quickswitch area 100 includes empty slots that can be filled by the user with avatars corresponding to one-to-one chats and/or group chats. Each avatar may comprise a picture. If no picture is chosen, the initials that correspond to the individual contact (if for a one-to-one chat) or the group may be displayed instead. Each avatar is displayed with a badge counter which indicates whether there are new messages within the corresponding chat. For example, when a particular chat has a new message, a badge counter can change in appearance so that the user can quickly determine that there is a new message and decide whether he should switch to that chat. Quickswitch area 100 may be horizontally scrollable so that a user can scroll through different pages of avatars. Alternatively, quickswitch area 100 could be vertically aligned, so that a user could vertically scroll through avatars. The user may scroll through quickswitch area 100, for example, by swiping in the direction desired to be scrolled in area 100, or by pressing button 109 or a similar button.

In one embodiment, the avatars in quickswitch area 100 are ordered according to the recency of the messages in the associated conversations. For example, conversations with the most recent message could appear at the leftmost portion of the currently displayed portion of quickswitch area 100. In this embodiment, when a new message appears in a conversation that is not currently open in active conversation area 102 or inactive conversation area 113, the avatar for that conversation moves to the leftmost part of the currently displayed portion of quickswitch area 100. Alternatively, conversations with the most recent message could appear at the rightmost portion of the currently displayed portion of quickswitch area 100. If quickswitch area 100 is vertically aligned instead of horizontally aligned, then the most recent conversation could appear at the uppermost or lowermost portion of the displayed portion of quickswitch area 100, depending on user preference.

The user has the ability to open a conversation that corresponds to an avatar in quickswitch area 100 by dragging that avatar from area 100 to either active conversation area 102 or inactive conversation area 113. Active conversation area 102 corresponds to a conversation in which the user is actively engaged and has a different visual appearance than inactive conversation area 113. Exemplary ways in which the appearances differ could include a different colored outline boxing active area 102 than inactive area 113, or making active conversation area 102 have 100% opacity while inactive area 113 can have less opacity to indicate its inactive state. In addition, the active conversation area 102 could be made to be larger than inactive conversation area 113. One of ordinary skill in the art will appreciate that there are numerous other ways in which the appearance of active conversation area 102 could be made to differ from inactive conversation area 113.

Active conversation area 103 may include a contact name 101 and avatar for the individual or group participating in the conversation with the user of the device. Active conversation area 103 also includes text boxes which contain messages that comprise the active conversation. For example, text box 106 may correspond to a message from the user of the device. This message and others belonging to the user differ visually from messages from other people, such as in text box 107. These differences could be based on color, pattern, or any other visual difference. In one embodiment, the user of device can collapse one or more of his own messages so that any collapsed message is replaced by an indicator 108 to save space in active region 102.

In order to enter a message for the conversation in active conversation area 103, the user of the device may enter a message in message box 103 using keyboard 105. Keyboard 105 may be a virtual keyboard displayed on a graphical user interface, or it may be a keyboard with physical buttons. The user can include various emoticons in a message or include a voice message using buttons included in area 103 or keyboard 105. The user can also include attachments to a message using attachment tray 104. One of ordinary skill in the art will appreciate that message entry configurations different than the ones depicted in FIG. 1 can be used in conjunction with a multichat feature.

Inactive conversation area 113 includes an avatar 110 and/or a contact name for the individual or group involved in the conversation associated with area 113. To save space, text from messages sent by the user of the device does not appear in inactive conversation area 113. Instead, indicator 111 appears in area 113, informing the user that the user in fact did send at least one message in the inactive conversation. In one embodiment, indicator 111 informs the user when and how many messages the user has sent in the inactive conversation. Text box 112, located in inactive conversation area 113 contains a message from a person participating in the inactive conversation other than the user of the device.

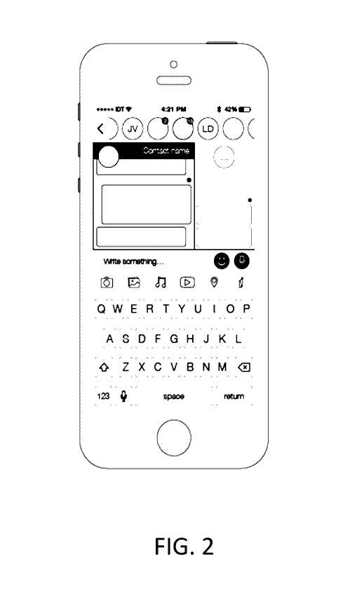

FIG. 2 depicts the ability to switch the active and inactive conversation areas. For example, a user of the device may switch the active conversation area 102 with the inactive conversation area 113 by either tapping the inactive region 102 or swiping the user's finger from the inactive area to the active area (or vice versa). The result is that the active area becomes the inactive area, and the inactive area becomes the active area. FIG. 2 shows the active area on the left side of the graphical user interface after the user has switched what was previously inactive area 113 in FIG. 1 to the active area. One of ordinary skill in the art will appreciate that the active and inactive conversation areas can be switched in ways other than tapping and swiping. For example, a user could place a cursor over the inactive (or active) conversation area, subsequently select the area over which the cursor is located (e.g., by pressing and holding a mouse button or pressing a keyboard key), drag the cursor to the active (or inactive, if the cursor originated in the active area) conversation area, and then indicating that the switching operation is done by letting go of the mouse button or keyboard key.

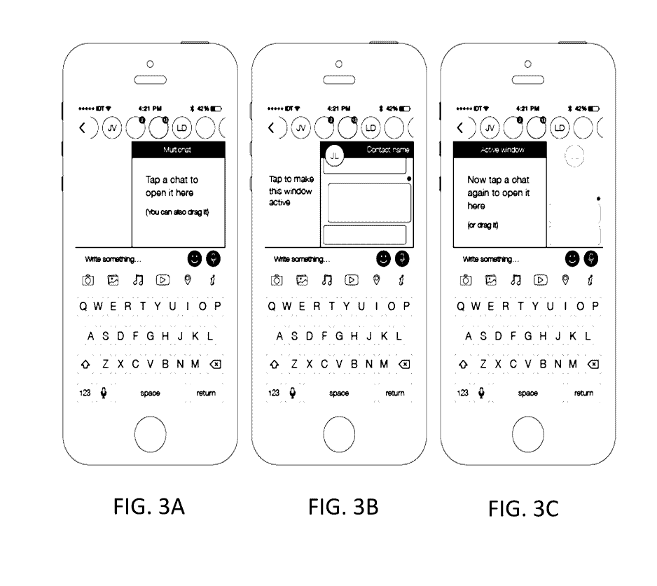

FIGS. 3A-3C depict a set of exemplary operations for a multichat messaging feature that is being used on a device for the first time. When the multichat messaging feature is activated for the first time, a short tutorial may be shown to teach the user the basic functionality of the feature. If the user has not added any chats to quickswitch area 100, it could be filled with the most recently active chats. If no chats exist, and therefore there are no chats to add to quickswitch area 100, the tutorial may ask the user to first create two new chats. Once quickswitch area 100 has at least two chats in it, the user can open two chats. First, the user can either tap (or click on) an avatar corresponding to a chat in quickswitch area 100 to open the chat in the active conversation area. Alternatively, the user can drag an avatar to the active conversation area. Then the user can tap or otherwise select the inactive conversation area to make that area the active conversation area. Thereafter, the user can either tap (or click on) an avatar corresponding to a chat in quickswitch area 100 to open the chat in the new active conversation area. Alternatively, the user can drag an avatar to the new active conversation area. Once the user has opened two chats, the multichat feature may start functioning normally. Successful setup of the feature may result in a notification being provided to the user that setup was a success.

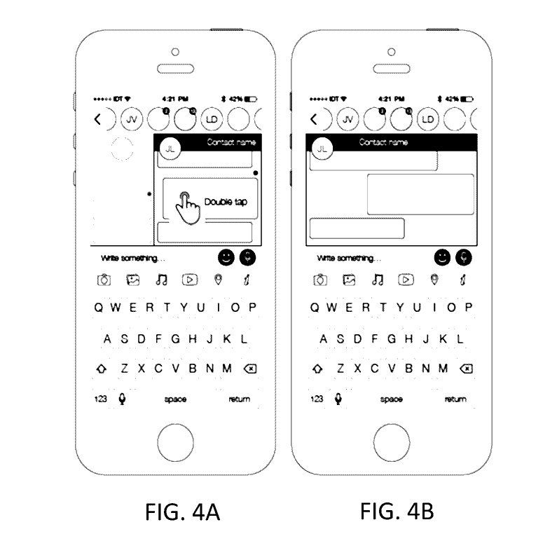

FIGS. 4A and 4B show a graphical user interface of a device with a multichat messaging feature closing a multichat mode and returning to single chat mode. FIG. 6A shows that one way to close the multichat feature is to double tap the active conversation area. The result is that the active conversation area is expanded and the inactive conversation area is closed, placing the device into normal (single) chat mode, as shown in FIG. 6B. One of ordinary skill in the art will appreciate that the multichat mode may be closed in a myriad of alternative ways. For example, instead of double tapping the active conversation area, a cursor could be placed over the active area and a mouse button double clicked or a designated keyboard button or buttons pressed. Or a designated “close” indicator located in the active conversation or elsewhere could be selected by tapping or clicking on it.

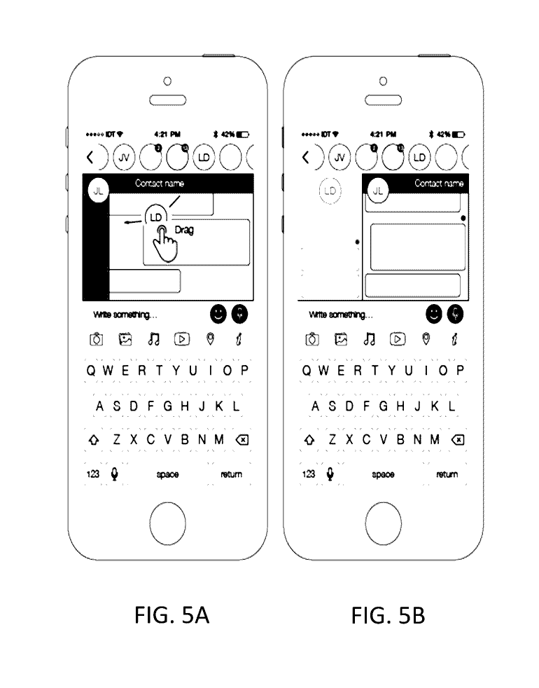

FIG. 5A is a diagram of a graphical user interface of a device depicting the activation of a multichat messaging feature. There are several ways that the multichat feature could be initiated while the device is in a single chat mode. One way is depicted in FIG. 5A. A user of the device may drag an avatar from quickswitch area 100 to the chat window, which is currently in single chat mode. As the avatar is dragged into the chat window, the chat window may decrease in size and a second window may appear next to the chat window, as shown in FIG. 5B. The second window that appears becomes the inactive conversation area of the multichat mode, and the previously existing chat window becomes the active conversation area of the multichat mode. Thereafter, the user may assign a chat to the inactive conversation area.

While certain configurations of structures have been illustrated for the purposes of presenting the basic structures of the present invention, one of ordinary skill in the art will appreciate that other variations are possible which would still fall within the scope of the appended claims.

1. A computer system for managing multiple chat sessions comprising:
a graphical display;
a computer processor;
a computer memory; and
computer code stored in the computer memory and configured to cause the processor to manipulate graphics on the graphical display, the computer code including:
computer code configured to cause the processor to display on the graphical display a quickswitch area;
computer code configured to cause the processor to display on the graphical display an active message area and an inactive message area, the active message area and the inactive message area being adjacent each other; and
computer code configured to cause the processor to send at least one message to participants associated with the active message area on behalf of a user of the computer system.

2. The computer system as claimed in claim 1, wherein the quickswitch area comprises a set of plural avatars.

3. The computer system as claimed in claim 1, wherein the set of avatars comprises at least one set of initials corresponding to at least one of (1) initials of a group and (2) initials of a contact.

4. The computer system as claimed in claim 1, wherein the computer system is a portable phone.

5. The computer system as claimed in claim 1, wherein the computer system is a tablet.

6. The computer system as claimed in claim 1, wherein the at least one message comprises at least one of a text message, an audio message and an image.

7. The computer system as claimed in claim 1, wherein the at least one message comprises a voicenote.

8. The computer system as claimed in claim 1, wherein the at least one message comprises an image.

9. The computer system as claimed in claim 1, wherein the at least one message comprises at least one of an image and a video captured using the computer system.

10. The computer system as claimed in claim 1, wherein the at least one message comprises at least one of an image and a video stored on the computer system.
